(19) United States
(12) Patent Application Publication
(10) Pub. No.: US 2010/0250791 A1
(43) Pub. Date: Sep. 30, 2010

(54) Low power physical layer for SATA and SAS transceivers

(75) Inventors: Joshua Johnson, Rochester, MN (US); David Smith, Rochester, MN (US); Steven Schauer, Loveland, CO (US); David Morgan, Fort Collins, CO (US); Bijan Eskandari-Ghamin, Littleton, CO (US)

Correspondence Address: IP Legal Services, 1500 East Lancaster Avenue, Suite 200, P.O. Box 1027, Paoli, PA, 19301, US

(73) Assignee: LSI Corporation

(21) Appl. No.: 12/412,641

(22) Filed: Mar. 27, 2009

(51) Int. Cl. G06F 3/00

(52) U.S. Cl. 710/18

(57) ABSTRACT

Described embodiments provide for switching from a low-power mode of a device such as, for example, a SAS or SATA receiver, to an active mode. The device enters the low-power mode by shutting down i) logic devices of a physical layer of the device and ii) a decoding circuit of the device. Activity at an input of a receiver of the device is detected while in low-power mode, and the device switches, in response to the detected activity, from the low-power mode to the active mode by powering up i) the logic devices of the physical layer and ii) the decoding circuit when activity is detected, thereby responding to the detected activity as if it is a predetermined command.

### BACKGROUND OF THE INVENTION

1. Field of the Invention

The present invention relates generally to data communications, and, in particular, to a low power physical layer implementation for SATA and SAS transceivers.

2. Description of the Related Art

In a computer hardware system, a host controller connects a host system (e.g., the computer) to other devices via a peripheral bus. For example, a host controller using the Small Computer System Interface (“SCSI”) protocol connects a SCSI disk to a computer via a SCSI peripheral bus. The SCSI bus is a parallel communications bus. The host controller communicates between the SCSI bus and the host computer's internal bus, typically by issuing commands to the devices attached to the SCSI bus. The SCSI bus is a multidrop bus, meaning that multiple components are connected to the same bus and a process of arbitration determines which device gets access to the bus at any point in time.

Serial Attached SCSI (“SAS”) is a serial protocol generally intended to replace the parallel SCSI bus technology. The SAS protocol utilizes differential signals and non-return to zero (“NRZ”) modulation. SAS uses the standard SCSI command set, but is point-to-point communication rather than multidrop communication. Each SAS device is connected by a dedicated bus to an initiator—a device that originates device service and task management requests to be processed by a target device. Initiators may be implemented as an on-board component on a computer motherboard or as a separate host controller. The SAS protocol generally supports a greater number of devices and higher data throughput than the SCSI protocol.

Serial Advanced Technology Attachment (“SATA”) devices generally offer slower data transfer rates than SAS devices, but, due to their lower cost, SATA devices are prevalent in many systems. SATA uses the standard ATA command set, however, in certain applications, a host controller might support both SAS and SATA devices. SATA devices are described in greater detail in the SATA-IO specification (Serial ATA International Organization: Serial ATA Revision 2.6, Feb. 15, 2007, hereinafter “SATA-IO specification”), the teachings of which are incorporated herein by reference.

As described in Section 8.1 of the SATA-IO Specification, the physical layer of a SATA communication system has three operating states: Active, Partial and Slumber. Active is the normal operating mode in which commands are passed over the link between a SATA host and a SATA device. In Active mode, the Phy logic devices are fully powered and operational, and are synchronized such that they are capable of transmitting and receiving data. Partial mode is a reduced power mode in which the Phy logic devices are powered but are in a neutral state. The SATA-IO Specification requires that it take no longer than 10 μs to return to Active mode from Partial mode. Slumber mode is a further reduced power mode. In Slumber mode, the Phy logic devices are powered, but are not driving the signal lines. The signal lines are instead allowed to be a floating common mode voltage. The SATA-IO Specification requires that it take no longer than 10 ms to return to Active mode from Slumber mode.

As described in Section 7.5 of the SATA-IO Specification, SATA devices are awakened from a “low power” mode by Out of Band (“OOB”) signaling. OOB signals are low data rate signal patterns that do not appear in normal data streams. For example, as further described in the SATA-IO Specification, OOB signals consist of leaving the signal lines of a transmitter idle for time intervals of predetermined length, followed by transmitting a signal pattern during burst intervals, each burst interval having a predetermined length. During the idle time intervals, the physical link between the transmitter and the receiver carries a DC common mode voltage. During OOB burst time intervals, a signal pattern appears on the link, corresponding to an OOB command. In the SATA-IO Specification, there are three OOB commands: COMRESET, COMINIT, and COMWAKE.

A SATA device will stay in a low-power mode (i.e. Partial or Slumber) until either a valid COMWAKE OOB command or a valid COMRESET OOB command is received. COMWAKE is the most frequently received OOB command while in Slumber mode, estimated at 99% of all received OOB commands. The COMWAKE OOB command is used to bring the Phy of a SATA device out of a low-power mode. As is described in greater detail in sections 7.5.1, 8.4.1 and 8.4.2 of the SATA-IO Specification, once the Phy is awake, the SATA device transmits a COMWAKE acknowledgement signal, typically a COMWAKE OOB signal, to the SATA host. The COMRESET OOB command is issued by the SATA host to force a hardware reset of a SATA device. As is described in the SATA-IO Specification, once the hardware reset is complete, the SATA device transmits a COMRESET acknowledgement signal, typically a COMINIT OOB signal, to the SATA host. The COMINIT OOB command is issued by a SATA device to acknowledge a COMRESET OOB command from the SATA host. As is described in greater detail in section 7.5.1.3 of the SATA-IO Specification, once the hardware reset is complete, the SATA device transmits a COMRESET acknowledgement signal, typically a COMINIT OOB signal, to the SATA host. In cases where a proper acknowledgement signal is not detected, the SATA host will re-transmit the COMRESET OOB command.

### SUMMARY OF THE INVENTION

The present invention provides for switching from a low-power mode of a device such as, for example, a SAS or SATA receiver, to an active mode. In described embodiments, the device enters the low-power mode by shutting down i) logic devices of a physical layer of the device and ii) a decoding circuit of the device. Activity at an input of a receiver of the device is detected while in low-power mode, and the device switches, in response to the detected activity, from the low-power mode to the active mode by powering up i) the logic devices of the physical layer and ii) the decoding circuit when activity is detected, thereby responding to the detected activity as if it is a predetermined command.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows a block diagram of a SATA communication system employing one or more embodiments of the present invention; and

FIG. 2 shows a flow diagram for a method of awakening a SATA transceiver from a low power state, in accordance with an exemplary embodiment of the present invention.

### DETAILED DESCRIPTION

In accordance with embodiments of the present invention, power consumption in, for example, a SAS or SATA transceiver device is reduced during a “low-power mode” of operation of the device. Logic devices operating at the Open Systems Interconnection Model's physical layer of the transceiver as well as the transceiver's reference clock are shut down upon entering the low-power mode. When activity is detected at the receiver of the device, the logic devices of the physical layer and the reference clock of the transceiver are powered up. A desired command is assumed, and the response either performs the wake-up as requested for the desired and assumed command, or, if the received activity does not correspond to the desired command but is a permitted command, the permitted command is performed at a subsequent reception of the command. Consequently, activity at the device receiver acts as a power-up command to exit low-power mode for the device. For clarity, the present specification generally refers to SATA devices, but as would be understood by one skilled in the art, the present invention is not limited only to SATA devices, and might be used with SAS devices, or any other similar devices.

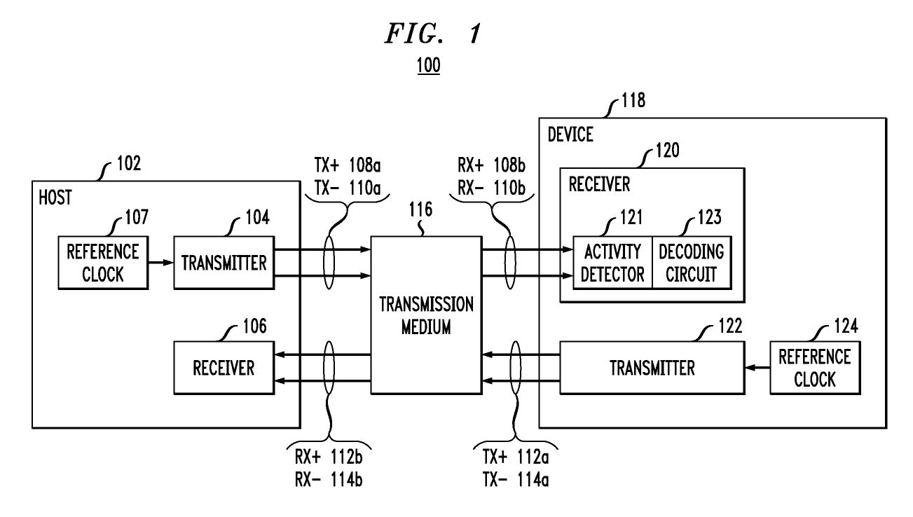

FIG. 1 shows a block diagram at the physical layer (“Phy”) of generic SATA communication system 100 that might employ one or more embodiments of the present invention. As shown in FIG. 1, SATA communication system 100 comprises SATA host 102 and SATA device 118, that communicate through transmission medium 116. For example, SATA device 118 might be a hard disk drive or other computer peripheral device, SATA host 102 might be a SATA controller on a computer motherboard. Transmission medium 116 might be a physical transmission medium such as a backplane or wired cable, but also might include some other type of connection, such as fiber-optic link or wireless link. SATA host 102 includes transmitter 104 and receiver 106, which are electrically coupled to transmission medium 116. SATA host 102 also includes reference clock 107 to provide a clock signal to transmitter 104. Reference clock 107 might be implemented using a phase-locked loop (“PLL”), such as described in section 7.3.2 of the SATA-IO Specification.

SAS and SATA protocols utilize differential signals, shown in FIG. 1 transmitted from differential signal pairs TX+ 108a and TX− 110a, and from differential signal pairs TX+ 112a and TX− 114a. After passing through transmission medium 116, the differential signals are received at differential signal pairs shown as RX+ 108b and RX− 110b, and RX+ 112b and RX− 114b, respectively. SATA device 118 includes receiver 120 and transmitter 122, which are electrically coupled to transmission medium 116. SATA device 118 also includes reference clock 124 to provide a clock signal to transmitter 122. Reference clock 124 might also be implemented using a phase-locked loop (“PLL”), such as is described in section 7.3.2 of the SATA-IO Specification. Receiver 120 is configured to receive signals 108 and 110 from transmitter 104. Transmitter 122 is configured to transmit signals 112 and 114 to receiver 106. Thus, a bi-directional differential link is formed between SATA host 102 and SATA device 118.

Receiver 120 also comprises activity detector 121 and decoding circuit 123. In an alternative embodiment of the present invention, receiver 106 of SATA host 102 might also comprise an activity detector and decoding circuit (not shown). Decoding circuit 123 comprises active digital circuitry to sample and decode received signals. For example, decoding circuit 123 might include a reference clock or other active digital circuitry. Activity detector 121 operates to detect changes in energy received at differential signal pairs RX+ 108b and RX− 110b. Changes in energy received at differential signal pairs RX+ 108b and RX− 110b, for example, might represent the signal energy of an OOB command sent by transmitter 104 of SATA host 102. Activity detector 121 might, for example, comprise a passive circuit such as a squelch detector such as shown in FIG. 166 of the SATA-IO Specification. When an input level received at differential signal pairs RX+ 108b and RX− 110b is above a predetermined threshold level, the squelch detector might output a signal indicating the presence of activity. The squelch detection circuit is physically small, does not require active digital circuitry, and does not require a reference clock to detect activity received at differential signal pairs RX+ 108b and RX− 110b. Alternatively, Activity Detector 121 might comprise a matched filter. As would be understood by one of skill in the art, a matched filter correlates a predetermined signal, for example the bit pattern of the COMWAKE OOB command, with the bit pattern of the signal received at differential signal pairs RX+ 108b and RX− 110b. When the predetermined signal and the received signal are the same, the output of the matched filter is a maximum value. Using a peak or threshold detector, the occurrence of this maximum value can be detected. Activity detector 121 might alternatively be any other energy detection circuit that does not require active digital circuitry or a reference clock.

As described previously, the Phy of SATA communication system 100 has three operating states: Active, Partial and Slumber. Active is the normal operating mode in which commands are passed over the link between SATA host 102 and SATA device 118. In Active mode, the Phy logic devices are fully powered and operational, and are synchronized such that they are capable of transmitting and receiving data. Partial mode is a reduced power mode in which the Phy logic devices are powered but are in a neutral state. The SATA-IO Specification requires that it take no longer than 10 μs to return to Active mode from Partial mode. Slumber mode is a further reduced power mode. In Slumber mode, the Phy logic devices are powered, but are not driving the signal lines 108, 110, 112 and 114. The signal lines are instead allowed to be a floating common mode voltage. The SATA-IO Specification requires that it take no longer than 10 ms to return to Active mode from Slumber mode.

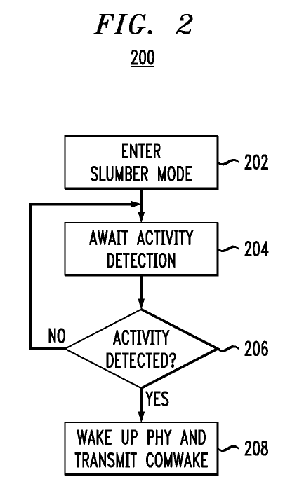

FIG. 2 shows a flow diagram for a method of awakening a SATA device from Slumber mode in accordance with an embodiment of the present invention. As shown in FIG. 2, SATA device 118 enters Slumber mode at step 202. At step 204, activity detector 121 of receiver 120 of SATA device 118 receives a signal indicating the presence of signal energy and, thus, activity, at the input to the receiver. Such presence of signal energy is might be from, for example, an OOB command sent by transmitter 104 of SATA host 102. However, such signal energy might be from other sources coupled to the transmission medium. No sampling or decoding is performed on the received signal energy because active decoding circuit 123 of receiver 120 of FIG. 1 is shut down to further reduce the power consumption of SATA device 118 in Slumber mode. At step 206, if any activity, for example any OOB command, is received, the process continues to step 208 where the logic devices of the Phy layer are powered up and a COMWAKE command is sent from transmitter 122 of SATA device 118 to receiver 106 of SATA host 102. If no activity, for example no OOB command, is detected at step 206, the process returns to step 204 to wait for activity to be received.

Thus, in an embodiment of the present invention, any detected activity at activity detector 121 of receiver 120 of SATA device 118 is assumed to be a desired command, for example a COMWAKE OOB command. By assuming that any received signal is a desired command, no sampling or decoding of the signal is necessary to switch from a low-power mode to a higher power mode where logic devices of the Phy are enabled. Thus, circuitry supporting receiver 120 such as, for example, decoding circuit 123 or a receiver reference clock (not shown), may be powered down or removed from the design, and the power consumption of SATA device 118 may be reduced. In some embodiments, shutting down decoding circuit 123 may reduce the power consumption of SATA device 118 in Slumber mode by at least 15%. Any received signal has a high probability of being the desired command, for example a COMWAKE OOB command, when the desired command is a frequently received command. For example, the COMWAKE OOB command is estimated to occur as approximately 99% of all received OOB commands. Thus, for the great majority of commands received in Slumber mode, SATA device 118 wakes up and functions properly.

In an alternative embodiment of the present invention, circuitry supporting receiver 106 such as, for example, decoding circuit 123, may also be powered down, and the power consumption of SATA host 102 may be reduced. Receiver 106 might be powered up when transmitter 104 of SATA host 102 is powered up to transmit a command, for example a COMWAKE OOB command or a COMRESET OOB command, to SATA device 118.

In the rare cases when the received signal is a permitted command but not the desired command, for example when the received signal is actually a COMRESET OOB command, SATA device 118 does not send a proper acknowledgement signal, for example the COMINIT OOB command. Consequently, in the absence of the proper acknowledgement signal, SATA host 102 times out for the first COMRESET OOB command, and sends another COMRESET OOB command. The second COMRESET OOB command is properly sampled and detected by receiver 120 of SATA device 118 since, after the first COMRESET OOB command is received, decoding circuit 123 of receiver 120 is powered up (for example, at step 208 of method 200 shown in FIG. 2). Thus, when the received signal is a COMRESET OOB command, approximately 10 ms latency is added because SATA host 102 resends the COMRESET OOB command after the first signal times out (such as specified at section 7.5.1 of the SATA-IO Specification). Thus, in order to reset the device from Slumber mode, two COMRESET OOB commands are sent instead of only one.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bit stream or other sequence of signal values electrically or optically transmitted through a medium, stored magnetic-field variations in a magnetic recording medium, etc., generated using a method and/or an apparatus of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

We claim:

1. A method of switching from a low-power mode of a device to an active mode, comprising:
a) entering the low-power mode by shutting down i) logic devices of a physical layer of the device and ii) a decoding circuit of the device;
b) detecting activity at an input of a receiver of the device while in low-power mode;
c) switching, in response to the detected activity, from the low-power mode to the active mode by powering up i) the logic devices of the physical layer and ii) the decoding circuit when activity is detected, thereby responding to the detected activity as if it is a predetermined command.

2. The invention of claim 1, wherein the method is implemented in a SAS receiver.

3. The invention of claim 1, wherein the method is implemented in a SATA receiver.

4. The invention of claim 1, wherein for step d) the predetermined command is a COMWAKE out of band command.

5. The invention of claim 4, wherein for step c), if the received activity is not the predetermined command, but is a permitted command, the method further comprising detecting and responding to a subsequent permitted command at the input of the receiver.

6. The invention of claim 5, wherein the permitted command is a COMRESET out of band command.

7. A machine-readable medium, having encoded thereon program code, wherein, when the program code is executed by a machine, the machine implements a method of switching from a low-power mode of a device to an active mode, comprising:
a) entering the low-power mode by shutting down i) logic devices of a physical layer of the device and ii) a decoding circuit of the device;
b) detecting activity at an input of a receiver of the device while in low-power mode;
c) switching, in response to the detected activity, from the low-power mode to the active mode by powering up i) the logic devices of the physical layer and ii) the decoding circuit when activity is detected, thereby responding to the detected activity as if it is a predetermined command.

8. The invention of claim 7, wherein the method is implemented in a SAS receiver.

9. The invention of claim 7, wherein the method is implemented in a SATA receiver.

10. The invention of claim 7, wherein for step d) the predetermined command is a COMWAKE out of band command.

11. The invention of claim 10, wherein for step d), if the received activity is not the predetermined command, but is a permitted command, step d) further comprises detecting and responding to a subsequent permitted command at the input of the receiver.

12. The invention of claim 11, wherein the permitted command is a COMRESET out of band command.

13. Apparatus for switching from a low-power mode of a device to an active mode, the apparatus comprising:
a circuit adapted to shut down i) logic devices of a physical layer of the device and ii) a decoding circuit of the device, thereby entering the low-power mode; and
an activity detector adapted to detect activity at an input of a receiver of the device while in low-power mode;
wherein the circuit is further adapted to switch, in response to the detected activity, from the low-power mode to the active mode by powering up i) the logic devices of the physical layer and ii) the decoding circuit when activity is detected by the activity detector, thereby responding to the detected activity as if it is a predetermined command.

14. The invention of claim 13, wherein the device is a SAS receiver.

15. The invention of claim 13, wherein the device is a SATA receiver.

16. The invention of claim 13, wherein the predetermined command is a COMWAKE out of band command.

17. The invention of claim 16, wherein if the received activity is not the predetermined command, but is a permitted command, the device is adapted to detect and respond to a subsequent permitted command at the input of the activity detector.

18. The invention of claim 17, wherein the permitted command is a COMRESET out of band command.

19. The invention of claim 13, wherein the apparatus is implemented in an integrated circuit.
